(19) United States
(12) Patent Application Publication
(10) Pub. No.: US 2019/0045822 A1
(43) Pub. Date: Feb. 14, 2019

(54) PROCESS FOR PREPARING A FLAVOURING COMPOSITION

(71) Applicant: ONYX DEVELOPPEMENT SAS, Malaunay (FR)

(72) Inventors: Jean Baptiste D'HUART, Malaunay (FR); Jean Paul LORAND, Malaunay (FR)

(21) Appl. No.: 16/079,886

(22) PCT Filed: Feb. 27, 2017
(86) PCT No.: PCT/FR2017/050433

§ 371 Date: Aug. 24, 2018

(30) Foreign Application Priority Data
Feb. 26, 2016 (FR) 16 51615

(51) Int. Cl. A23L 27/24; A23L 11/00

(52) U.S. Cl. CPC A23L 27/25; A23V 2002/00; A23L 11/09

(57) ABSTRACT

Disclosed is a process for preparing a flavoring composition, including the steps consisting of: (i) preparing a fermentation substrate including:—a source of plant origin chosen from the group consisting of oleaginous plants, oleaginous-proteaginous plants, proteaginous plants, cereals, leguminous plants, seeds, tubers and rhizomes and/or leaves of ligneous and non-ligneous forest products and mixtures thereof, and—a liquid of non-animal origin which is immiscible with a fatty phase; (ii) adding a source of fatty acid essentially of plant origin to the fermentation substrate; (iii) fermenting the mixture obtained in step (ii), wherein the mixture obtained in step (ii) is pre-inoculated with microorganisms; and (iv) recovering the flavoring composition obtained.

### RELATED PATENT APPLICATIONS

The present application is filed pursuant to 35 U.S.C. § 371 as a U.S. National Phase Application of International Patent Application No. PCT/FR2017/050433, which was filed on Feb. 27, 2017, claiming the benefit of priority to French Patent Application No. FR 16 51615 filed on Feb. 26, 2016. The content of each of the aforementioned Patent Applications is incorporated herein by reference in its entirety.

### PROCESS FOR PREPARING A FLAVOURING COMPOSITION

The present invention relates to a process for preparing a flavouring composition.

It also relates to a fermentation support inoculated with a microorganism, said fermentation support comprising a source of plant origin, a source of fatty acid essentially of plant origin and a liquid of non-animal origin which is immiscible with a fatty phase.

Finally, it describes the use of a source of plant origin in a fermentation support inoculated with a microorganism, said fermentation support comprising a source of fatty acid essentially of plant origin for developing cheese flavour.

A flavour is an odorous substance released from various substances of animal or plant origin.

The constituents of flavours are simple molecules, of low molecular mass (M<400 Dalton) and wherein the vapour pressure at atmospheric pressure and at ambient temperature is sufficiently high such that said molecules are partially found in the vapour state in the gaseous atmosphere, and that they can induce a stimulus in contact with the olfactory mucosa.

There are a multitude of different flavours, such as for example the “cheese” flavour category.

The production of flavours in cheese is due to a plurality of successive and/or concomitant raw material conversion reactions: aromatisation originates from the metabolisation of proteins, fats, and carbohydrates by various microorganisms and/or enzymes, present in the environment.

Among the various reactions, mention may be made of:
proteolysis which is the breakdown of proteins under the action of proteases into peptides or amino acids. These amino acids will subsequently serve as precursors for various transamination, dehydrogenation, decarboxylation, or reduction reactions, enabling the creation of flavouring molecules.
lipolysis which is the breakdown of lipids (generally triglycerides) into fatty acids. These fatty acids will undergo transformations leading to the development of aromatic molecules (particularly for short-chain fatty acids). They may also serve as precursors to form further aromatic compounds (particularly for long-chain fatty acids).
glycolysis which is the breakdown of sugars, used as a source of energy.
   They do not produce flavours but the breakdown products thereof (pyruvate) once degraded, serve as precursors for aromatic molecules (diacetyl, acetoin).

The breakdown of fatty acids is particularly responsible for the formation of blue-veined cheese flavours.

Fats have significant properties from an organoleptic point of view. As they are immiscible with water, they will affect the texture, add creaminess and increase the viscosity of the food.

The biological breakdown of triglycerides starts with the action of lipases which will produce free fatty acids, monoglycerides and diglycerides, and glycerol by hydrolysis.

The β-oxidation of saturated fatty acids (short-chain fatty acids) is conducted under aerobic conditions and enables the formation of methyl ketones.

In camembert and blue cheeses, methyl ketones are by far the most abundant volatile compounds (in the range of 25 to 60 μmoles per 100 g of fat), the two major substances being nonan-2-one and heptan-2-one.

Unsaturated fatty acids, as for them, via the action of a monooxygenase, may form hydroxylated fatty acids, precursors of lactones, conferring fruity or fatty notes on foods.

Flavours may be synthesised via fermentation of microorganisms resulting in the production of odorous molecules.

The nature of the fermenting agents is particularly dependent on the flavour to be synthesised.

For example, regarding cheese flavour, Penicillium spp is a mould genus well-known and used in the food industry for the usefulness thereof in the manufacture and flavouring of specific cheeses such as Camembert or Roquefort.

Penicillium roquefortii strains convert fatty acids in the form of various methyl ketones, the main molecules responsible for the flavour of blue-veined cheese.

The fats required for the production of flavour by the fermenting agents may be of animal or plant origin.

However, the production of a flavour from fats of plant origin offers numerous advantages.

Indeed, vegetarian diets require a plant origin of foods and/or condiments.

Furthermore, wet raw materials of animal origin are generally much more difficult to store than dry plant-based raw materials such as for example oleaginous seeds.

Moreover, the negative environmental impacts of meat production, both intensive and extensive, are increasingly being highlighted. They mainly result in a risk of degradation of water quality, substitution of forests by pastures, a decrease in biodiversity or indeed greenhouse gas production.

Finally, the availability of animal products will decline over the next 50 years.

It would as such be desirable to find an alternative to the flavours produced from animal-based raw materials such as for example milk.

However, the present inventors have discovered that a process for preparing a flavouring composition from raw materials essentially of plant origin would make it possible to meet these needs.

### Process

As such, the present invention firstly relates to a process for preparing a flavouring composition, comprising the steps consisting of:

(i) preparing a fermentation support comprising (essentially):
a source of plant origin chosen from the group consisting of oleaginous plants, oleaginous-proteaginous plants, proteaginous plants, cereals, leguminous plants, seeds, tubers, rhizomes and/or leaves of ligneous and non-ligneous forest products and mixtures thereof;
a liquid of non-animal origin which is immiscible with a fatty phase; and
optionally less than 2% by mass of dextrose and less than 0.4% by mass of lactose with respect to the total mass of the fermentation support,

(ii) adding a source of fatty acid essentially of plant origin to the fermentation support;

(iii) fermenting the mixture obtained in step (ii), the mixture obtained in step (ii) being pre-inoculated with microorganisms; and

(iv) recovering the flavouring composition obtained.

### Step (i): Preparing the Fermentation Support

According to the invention, the fermentation support comprises a source of plant origin chosen from the group consisting of oleaginous plants, oleaginous-proteaginous plants, proteaginous plants, cereals, leguminous plants, seeds, tubers and rhizomes and/or leaves of ligneous and non-ligneous forest products and mixtures thereof.

A typical manner of introducing microorganisms into a fermentation support according to the present invention may consist of using a source of inoculated bread, such as breadcrumbs. Indeed, such a source of bread, carrying microorganisms, cannot be considered as a fermentation support according to the present invention as it does not enable the in extenso fermentation described herein (step i, ii and ii above).

Nevertheless, according to one particular embodiment of the invention, the fermentation support may be free from any source of bread or any other form of bread (slices, fractions of all sizes of bread such as inoculated breadcrumbs, entire loaves), broths or suspensions obtained by cooking in liquid or semi-liquid phase using a source of bread.

According to one more particular embodiment of the invention, the fermentation support comprises a source of plant origin chosen from the group consisting of oleaginous plants, oleaginous-proteaginous plants, proteaginous plants, leguminous plants, seeds, tubers and rhizomes and/or leaves of ligneous and non-ligneous forest products, and mixtures thereof.

The fermentation in step iii is performed under aerobic or anaerobic conditions.

According to one embodiment, the source of plant origin is chosen from oleaginous plants.

According to one embodiment combined with the preceding embodiment, the oleaginous plant is chosen from the group consisting of peanut, soya, coconut, sunflower, flax, cotton and mixtures thereof.

Indeed, it has been demonstrated that the use of a fermentation support comprising a source of plant origin as defined in the present invention, such as for example oleaginous plants, would make it possible to obtain a flavouring composition having a greater aromatic concentration than that obtained with a growth medium described by the bibliography.

The source of plant origin is found in the fermentation support in the form of a suspension.

As such, according to the invention the source of plant origin defined in the present invention is mixed with a liquid of non-animal origin which is immiscible with a fatty phase, such as for example water or a water-enriched plant source.

According to one embodiment, the mass ratio between the liquid of non-animal origin which is immiscible with the fatty phase and the source of plant origin is between 5 and 20, preferably between 8 and 13.

The present invention also relates to a process for preparing a flavouring composition, comprising the steps consisting of:

(i) preparing a fermentation support comprising (essentially):
a source of plant origin chosen from the group consisting of oleaginous plants, oleaginous-proteaginous plants, proteaginous plants, cereals, leguminous plants, seeds, tubers, rhizomes and/or leaves of ligneous and non-ligneous forest products and mixtures thereof;
a liquid of non-animal origin which is immiscible with a fatty phase; and

(ii) adding a source of fatty acid essentially of plant origin to the fermentation support;

(iii) fermenting the mixture obtained in step (ii), the mixture obtained in step (ii) being pre-inoculated with microorganisms; and

(iv) recovering the flavouring composition obtained,

wherein the mass ratio between the liquid of non-animal origin which is immiscible with the fatty phase and the source of plant origin is between 5 and 20, preferably between 8 and 13.

The fermentation in step iii is performed under aerobic or anaerobic conditions.

According to one embodiment, the plant source undergoes wet grinding followed by high-pressure homogenisation to prevent settling phenomena.

Advantageously, the plant source has not undergone processing such as for example peeling, stoning or deseeding.

Indeed, in the case of seeds, the raw material is not necessarily hulled. This makes it possible to start with unprocessed raw materials directly available in developing countries.

### Step (ii): Adding a Source of Fatty Acid To the Fermentation Support

According to the invention, the source of fatty acids essentially of plant origin is presented in the form of triglycerides or free fatty acids or salts thereof.

According to one particular embodiment, the source of fatty acid is triglycerides as this is a source naturally available in developing countries.

According to one particular embodiment according to the present invention, the fermentation support comprises less than 2%, 1.5%, 1%, 0.8%, 0.5%, or less than 0.1% by mass of dextrose with respect to the total mass of the fermentation support. According to one particular embodiment according to the present invention, the fermentation support is free from dextrose.

According to one particular embodiment according to the present invention, the fermentation support comprises less than 0.4%, 0.3%, 0.2%, 0.15%, 0.1%, or less than 0.05% by mass of lactose with respect to the total mass of the fermentation support. According to one particular embodiment according to the present invention, the fermentation support is free from lactose, and more generally from sugar of animal origin.

The ranges of values (including 0%) as described in the two paragraphs above of dextrose, lactose, and more generally of sugar of animal origin, in the fermentation support, may all be combined with one another.

By “essentially of plant origin”, it is understood that the source of fatty acids of plant origin represent more than 50%, even more than 70%, preferably more than 90%, and even more preferentially more than 95% by weight of the total weight of the source of fatty acids.

According to one particular embodiment, the source of fatty acids is solely of plant origin.

According to one embodiment, the fatty acids are fatty acids ranging from short chains to medium chains.

These are typically fatty acids having a carbon chain length between C₄ and C₁₂, preferably between C₆ and C₁₂.

According to one embodiment, the source of fatty acid is chosen from the group consisting of coconut oil, palm kernel oil, babassu oil, and extracts of plant oils rich in short- and medium-chain fatty acids such as purified capric acid and caprylic acid, and mixtures thereof.

According to one embodiment, the source of fatty acid is added in a quantity between 20 and 40% with respect to the total weight of the fermentation support presented in the form of a suspension.

According to the invention, the source of fatty acid may be added in one go or, preferably, gradually (“fed batch” principle) so as to prevent inhibition of fermentation.

According to the invention, the fermentation support is therefore three-phase. It comprises an aqueous phase of non-animal origin originating from the liquid which is immiscible with the fatty phase, a solid phase originating from the source of plant origin and a fatty phase originating from the source of fatty acid and optionally also from the source of plant origin.

As such, it may consist of an “oil-in-water”, “water-in-oil” emulsion, an “oil in (water and solid) suspension” or a “suspension in oil”.

According to the invention, when the source of fatty acid is triglycerides, the process comprises an additional fatty acid hydrolysis step.

This step is described hereinafter and takes place prior to fermentation.

The hydrolysis reaction will preferably be total so as to optimise the conversion yields into aromatic molecules.

According to one embodiment, the triglycerides forming the lipid phase are mixed with water and stirred so as to form an emulsion.

Then, hydrolysis of the triglycerides is carried out by adding enzymes to the mixture comprising the aqueous phase of non-animal origin and the triglycerides (the emulsion).

Mention may be made by way of enzyme, for example, of lipases, esterases and cutinases of plant and microbial origin, such as Palatase®, Lipopan®, Lipomax® but also other lipases such as those derived from GMOs.

According to one particular embodiment, the enzyme used is a mixture of Palatase® with Lipopan® (Aspergillus Orizae).

According to one embodiment, the quantity of enzyme used is between 0.1 and 2%, preferably between 0.15 and 0.5% by mass of the dry extract of the medium.

The term “dry extract of the medium” means the residue mass obtained after dehydration in an oven or on a thermobalance with respect to the initial mass.

According to one embodiment, hydrolysis is carried out for a duration between 12 hours and 48 hours, preferably between 18h and 30h at a temperature between 30° C. and 70° C., preferably between 35° C. and 45° C.

According to one embodiment, a heat treatment carried out at a temperature between 80 and 140° C. is carried out so as to inactivate the enzymes.

### Step (iii): Fermentation

The fermentation support comprising (essentially) at present:
the source of plant origin chosen from the group consisting of oleaginous plants, oleaginous-proteaginous plants, proteaginous plants, cereals, leguminous plants, seeds, tubers, rhizomes and/or leaves of ligneous and non-ligneous forest products and mixtures thereof;
the liquid of non-animal origin which is immiscible with a fatty phase;
the source of fatty acid of plant origin, hydrolysed when the source of fatty acids is presented in the form of triglycerides;

is inoculated with microorganisms which will partially metabolise the hydrolysed fatty acids.

According to one embodiment, the fermentation support is pre-pasteurised so as to prevent the growth of contaminant floras.

Pasteurisation may be carried out using techniques well known to those skilled in the art. For example, the medium may be heated at 90° C. for 15 minutes.

According to the invention, the term “microorganisms” means any substance interacting with the fermentation support and enabling flavour production.

Mention may be made for example of moulds (in spore or mycelium form), bacteria as well as more or less purified enzyme extracts from moulds and bacteria.

As such, according to one embodiment, the fermentation substrate is inoculated with microorganisms chosen from the group consisting of Penicillium roqueforti, Penicillium album, Geotrichum candidum, Staphylococcus carnosus and Staphylococcus xylosus spores.

According to one embodiment, the microorganisms are added in a quantity between 10⁸ to 10¹⁰ Colony-Forming Units (CFU) per 100 kg of fermentation support.

Fermentation may be carried out with any type of fermenters. Mention may be made for example of the batch, fed-batch and continuous fermenter.

According to one embodiment, fermentation is carried out at a temperature between 10 and 30° C. for a duration between 10 and 300 hours, preferably between 50 and 100 hours.

According to a further embodiment, the pH of the medium during fermentation is between 5 and 7 as this is the optimum pH for producing methyl ketones with the use of Penicillium roqueforti spores.

### Steps (iv): Recovery

According to the invention, the aromatic compounds are extracted from the fermentation support (after fermentation) since the latter are concentrated in the fatty phase.

It is possible for example to use organic solvents to perform a liquid/liquid extraction.

According to a further embodiment, the aromatic compounds are adsorbed onto a hydrophobic matrix and then desorbed after various rinsings.

In this embodiment, a non-polluting method by physical destabilisation of the emulsion is chosen.

According to one embodiment when fermentation is complete, the mixture undergoes centrifugation, typically at 3000 G followed by static settling. The aromatic concentrate may also be obtained by continuous settling.

According to one embodiment, the mixture (before and after settling) undergoes a heat treatment (typically at 121° C. for 5 min) so as to kill the microorganisms and deactivate the enzymatic systems thereof.

The oil and water fractions in the liquid are then separated by emptying the settling vessel either by overflow or via the bottom.

This static separation step is advantageously replaced by continuous settling.

The oil fraction is used directly as a flavouring composition.

It is also possible to use the flavouring composition in powder form. To do so, the oil fraction is adsorbed on an organic support such as cyclodextrin or on a mineral support such as colloidal silica.

It is also possible to mix the oil fraction with a drying support such as maltodextrin in an aqueous emulsion and subsequently dry same by spraying in a hot air flow (atomisation).

### Fermentation Support

The present invention secondly relates to a fermentation support comprising:
a source of plant origin chosen from the group consisting of oleaginous plants, oleaginous-proteaginous plants, proteaginous plants, cereals, leguminous plants, seeds, tubers and rhizomes and/or leaves of ligneous and non-ligneous forest products, and mixtures thereof,
a source of fatty acid essentially of plant origin, and
a liquid of non-animal origin which is immiscible with a fatty phase,

said fermentation support being intended to be inoculated with microorganisms.

According to one embodiment, the liquid of non-animal origin which is immiscible with the fatty phase is chosen from the group consisting of water, or a water-enriched plant source.

According to one embodiment, the source of plant origin is chosen from oleaginous plants.

According to one embodiment combined with the preceding embodiment, the oleaginous plant is chosen from the group consisting of peanut, soya, coconut, sunflower, flax, cotton and mixtures thereof.

Indeed, it has been demonstrated that the use of a fermentation support comprising oleaginous plants would make it possible to obtain a flavouring composition having a greater aromatic concentration than that obtained with a growth medium described by the bibliography.

The source of plant origin is found in the fermentation support in the form of a suspension.

According to one embodiment, the plant source undergoes wet grinding followed by high-pressure homogenisation to prevent settling phenomena.

Advantageously, the plant source has not undergone processing such as for example peeling, stoning or deseeding.

According to the invention, the source of fatty acids essentially of plant origin is presented in the form of triglycerides or free fatty acids or salts thereof.

According to one particular embodiment, the source of fatty acid is triglycerides as this is a source naturally available in developing countries.

By “essentially of plant origin”, it is understood that the source of fatty acids of plant origin represent more than 50%, even more than 70%, preferably more than 90%, and even more preferentially more than 95% by weight of the total weight of the source of fatty acids.

According to one embodiment particular, the source of fatty acids is solely of plant origin.

According to one embodiment, the fatty acids are fatty acids ranging from short chains to medium chains.

These are typically fatty acids having a carbon chain length between C₄ and C₁₂, preferably between C₆ and C₁₂.

According to one embodiment, the fatty acids are chosen from the group consisting of coconut oil, palm kernel oil, babassu oil, and extracts of plant oils rich in short- and medium-chain fatty acids such as purified capric acid and caprylic acid, and mixtures thereof.

According to the invention, the fermentation support is intended to be inoculated with microorganisms.

Mention may be made for example of moulds (in spore or mycelium form), bacteria as well as more or less purified enzyme extracts from moulds and bacteria.

As such, according to one embodiment, the fermentation support is intended to be inoculated with microorganisms chosen from the group consisting of Penicillium roqueforti, Penicillium album, Geotrichum candidum, Staphylococcus carnosus and Staphylococcus xylosus spores.

According to one embodiment, the microorganisms are added in a quantity between 10⁸ to 10¹⁰ Colony-Forming Units (CFU) per 100 kg of fermentation support.

According to one embodiment, the fermentation support, presented in the form of an emulsion, comprises:
5 to 10% of the source of plant origin;
35 to 40% of the source of fatty acid;
50 to 60% of the liquid of non-animal origin which is immiscible with the fatty phase; and
10⁸ to 10¹⁰ CFU of microorganisms

with respect to the total weight of the fermentation support.

The invention further relates to the use of a source of plant origin chosen from the group consisting of oleaginous plants, oleaginous-proteaginous plants, proteaginous plants, cereals, leguminous plants, seeds, tubers and rhizomes and/or leaves of ligneous and non-ligneous forest products, and mixtures thereof in a fermentation support inoculated with microorganisms and comprising a source of essentially plant-based fatty acid for developing cheese flavour.

Finally, the invention lastly relates to a food and/or condiment comprising the flavouring composition obtained according to the process defined in the present invention.

### COMPARATIVE EXAMPLE: PREPARATION OF A BLUE CHEESE FLAVOUR

In the examples hereinafter, the percentages are expressed as a mass percentage.

### Example A: Process According to the Invention→Fermentation Support Comprising Oleaginous Plants and Water

In this example, the process comprises the following steps:

a) preparation of the fermentation support
12 kg of peanut seeds are ground in liquid phase with 108 kg of water and then homogenised at 550 bars. The insoluble fractions of the seed as well as the peanut oil fat globules (approximately 50% of the mass of the seeds) are thus kept in suspension

b) Adding the source of fatty acid of plant origin
14.6 kg of liquid coconut oil (70° C.) (fatty acid) with 1% m/m of Lactem P22 ® emulsifier (Dupont-Danisco) are added gradually while providing a high shear with a rotating propeller at 9000 rpm to 25.2 kg of fermentation support pre-heated to a temperature of 70° C.;
The 40 kg of emulsion is placed in a 150-litre fermenter;
A 15-minute heat treatment at 90° C. is carried out to kill the bacteria in vegetative form

c) Hydrolysis
a lipase mixture: 8 g of Palatase® and 8 g of Lipopan® are added to the preceding mixture so as to hydrolyse the fatty acids;
The mixture thereby obtained is kept at a temperature of 40° C. for 20h;
Then, the mixture is heated at a temperature of 90° C. for 15 minutes so as to deactivate the enzymes;

d) Fermentation
5.2 g (or 4.8.10⁸ CFU) of P. roqueforti spores are added to the 40kg of emulsion;
Sterile air is injected at 40 L/min so as to measure 3.9 mg/L of 02
After 84 hours, the dissolved oxygen is reduced to 0.7 mg/L and a strong odour of Roquefort escapes from the fermenter.

e) Recovering the flavour

In order to stabilise and recover the aromatic fraction, 20% of salt m/m is added and the whole is sterilised for 30 minutes at 120° C.

Centrifugation of the emulsion pre-heated to 70° C. is then carried out, making it possible to recover 65% of fat content in aromatic oil form.

### Example B: Process Comprising a Fermentation Support Comprising Sodium Citrate, Dextrose and Water

In this example, the experimental conditions described in example 1 of the patent EP 0312 746 are used [loose translation into French of Example 1 of EP0312746]:

A) Hydrolysed Coconut Oil Production

Seventeen parts coconut oil were heated to a temperature of 35-40° C. Then, 79 parts water were added to the coconut oil. This mixture was heated to 37° C. A suspension of 4 parts water and 0.1 parts lipase (from Rhizopus oryzae) were added to the oil-in-water mixture. This mixture was stirred in an open vessel using a Polytron, from Tekmar at 37° C. for 1 hour. The pH was monitored and kept at a pH of 7.0 with 5-10 parts of a 25% NaOH solution throughout the reaction. The temperature was increased to 100° C. and maintained at 100° C. for 7 to 15 minutes according to the size of the sample in order to deactivate the lipase. The hydrolysed oil-in-water mixture is then used in the blue (cheese) flavour production process.

B) Inoculum Preparation

A mixture of 0.5 parts dextrose, 0.5 parts sodium citrate and 20 parts water was prepared in a vacuum and filtered through a sterile filter (0.45 μm). Four parts Penicillium roqueforti spores (dried on breadcrumbs—“Midwest Blue Mold—Dairyland Food Labs”) were added to the sterile filtrate mixture, which was mixed to disperse the spores in the water to prepare a suspension.

C) Blue (Cheese) Flavour Production

Seventeen parts hydrolysed coconut oil/water from section A of this example containing 14 parts water, 1.5 parts free fatty acids or salts thereof, and 1.5 parts non-hydrolysed oil were mixed with 57.60 parts water and placed either in a sterilisable fermenter or in an asepticised closed lined vessel (if placed in an asepticised closed lined vessel, the water must be sterilised i.e. boiled). The mixture, the temperature whereof was 30° C., was stirred while the Penicillium roqueforti spore suspension as prepared in section B of this example was slowly added to the vessel. The pH of the reaction mixture was measured and if it was not equal to pH 6.0, the pH was then adjusted to 6.0 using 50% NaOH if the solution was acidic, or 33% HC1 if the solution was alkaline.

The vessel was subjected to aeration by bubbling at a flow rate of 800 cm³/min/L of substrate. The vessel contained a further opening so that the pressure could not build up, but a positive air flow was maintained. The reaction was carried out for 8 hours while keeping the temperature of the product at 30° C. with aeration and continuous stirring throughout the 8-hour period. Once the 8-hour period had elapsed, the product was centrifuged or settled (to remove the breadcrumbs whereon the spores were inoculated), and then dried. The liquid product was then “HTST” pasteurised to deactivate the Penicillium roqueforti spores. The product was separated into oil and water fractions. The oil phase as such contains most of the aromatic compounds (methyl ketones) and may be used as seasoning as such.

The culture medium described in this document (EP0312746) differs from the culture medium of the present invention particularly in that it replaces the fermentation support by dextrose and sodium citrate.

The aromatic concentrates produced in example A and in example B were formulated in neutral dairy preparations at a dose of 1.5% with respect to the total weight of the mixture and resulted in the perception of notes of blue-veined cheese.

The perception was more intense and characteristic for the tasting based on example A compared to that based on example B.

The chromatographic analysis data hereinafter show the methyl ketone concentrations.

In these examples, 4 methyl ketones were quantified, the two mainly responsible for the flavouring of blue cheeses are 2-heptanone and 2-nonanone.

| Compounds | LoQ (mg · kg−1) | Oil example A | Oil example B |
|---|---|---|---|
| 2-pentanone | 0.5 | 79.0 | 8.2 |
| 2-heptanone | 0.5 | 96.7 | 76.7 |
| 2-nonanone | 0.5 | 44.7 | 37.9 |
| 2-undecanone | 0.5 | 29.2 | 18.8 |

LoQ = limit of quantification

As such, the use of a fermentation support comprising oleaginous plants makes it possible to obtain a flavouring composition having a greater aromatic concentration than that obtained with a medium devoid of oleaginous plants.

1. Process for preparing a flavouring composition, comprising the steps consisting of:
(i) preparing a fermentation support comprising:
a source of plant origin chosen from the group consisting of oleaginous plants, oleaginous-proteaginous plants, proteaginous plants, cereals, leguminous plants, seeds, tubers, rhizomes and/or leaves of ligneous and non-ligneous forest products and mixtures thereof; and
a liquid of non-animal origin which is immiscible with a fatty phase,
less than 2% by mass of dextrose and less than 0.4% by mass of lactose with respect to the total mass of the fermentation support;
(ii) adding a source of fatty acid essentially of plant origin to the fermentation support;
(iii) fermenting the mixture obtained in step (ii), the mixture obtained in step (ii) being pre-inoculated with microorganisms; and
(iv) recovering the flavouring composition obtained.

2. Preparation process according to claim 1, wherein the fermentation support in preparation step (i) essentially comprises:
a source of plant origin chosen from the group consisting of oleaginous plants, oleaginous-proteaginous plants, proteaginous plants, cereals, leguminous plants, seeds, tubers, rhizomes and/or leaves of ligneous and non-ligneous forest products and mixtures thereof; and
a liquid of non-animal origin which is immiscible with a fatty phase.

3. Preparation process according to claim 1, wherein the source of fatty acid is chosen from the group consisting of coconut oil, palm kernel oil, babassu oil, and extracts of plant oils rich in short- and medium-chain fatty acids such as purified capric acid and caprylic acid, and mixtures thereof.

4. Preparation process according to claim 3, wherein when the source of fatty acid is triglycerides, the process comprises a triglycerides hydrolysis step prior to the fermentation step.

5. Preparation process according to claim 1, wherein the source of plant origin is at least one oleaginous plant chosen from the group consisting of peanut, soya, sunflower, coconut, flax, cotton and mixtures thereof.

6. Preparation process according to claim 1, wherein the microorganisms introduced into the fermentation support are chosen from the group consisting ofPenicillium roqueforti, Penicillium album, Geotrichum candidum, Staphylococcus carnosus and Staphylococcus xylosus spores.

7. Fermentation support comprising:
less than 2% by mass of dextrose and less than 0.4% by mass of lactose;
a source of plant origin chosen from the group consisting of oleaginous plants, oleaginous-proteaginous plants, proteaginous plants, cereals, leguminous plants, seeds and/or leaves of ligneous and non-ligneous forest products, tubers and rhizomes and mixtures thereof,
a source of fatty acid essentially of plant origin; and
a liquid of non-animal origin which is immiscible with a fatty phase,
said fermentation support being intended to be inoculated with microorganisms.

8. Fermentation support according to claim 7, wherein the fermentation support essentially comprises:
a source of plant origin chosen from the group consisting of oleaginous plants, oleaginous-proteaginous plants, proteaginous plants, cereals, leguminous plants, seeds and/or leaves of ligneous and non-ligneous forest products, tubers and rhizomes and mixtures thereof,
a source of fatty acid essentially of plant origin; and
a liquid of non-animal origin which is immiscible with a fatty phase.

9. Fermentation support according to claim 7, wherein the oleaginous plants are chosen from the group consisting of peanut, soya, sunflower, coconut, flax, cotton and mixtures thereof.

10. Fermentation support according to claim 7, wherein the mass ratio between the liquid of non-animal origin which is immiscible with the fatty phase and the source of plant origin is between 5 and 20.

11. A fermentation support inoculated with microorganisms and comprising a source of essentially plant-based fatty acid, the fermentation support comprising a source of plant origin chosen from the group consisting of oleaginous plants, oleaginous-proteaginous plants, proteaginous plants, cereals, leguminous plants, seeds, tubers and rhizomes and/or leaves of ligneous and non-ligneous forest products, and mixtures thereof, the fermentation support being suitable for developing cheese flavour.

12. Food and/or condiment comprising the flavouring composition obtained according to the process as defined in claim 1.

13. Preparation process according to claim 2, wherein the source of fatty acid is chosen from the group consisting of coconut oil, palm kernel oil, babassu oil, and extracts of plant oils rich in short- and medium-chain fatty acids such as purified capric acid and caprylic acid, and mixtures thereof.

14. Preparation process according to claim 2, wherein the source of plant origin is at least one oleaginous plant chosen from the group consisting of peanut, soya, sunflower, coconut, flax, cotton and mixtures thereof.

15. Preparation process according to claim 3, wherein the source of plant origin is at least one oleaginous plant chosen from the group consisting of peanut, soya, sunflower, coconut, flax, cotton and mixtures thereof.

16. Preparation process according to claim 4, wherein the source of plant origin is at least one oleaginous plant chosen from the group consisting of peanut, soya, sunflower, coconut, flax, cotton and mixtures thereof.

17. Preparation process according to claim 2, wherein the microorganisms introduced into the fermentation support are chosen from the group consisting of Penicillium roqueforti, Penicillium album, Geotrichum candidum, Staphylococcus carnosus and Staphylococcus xylosus spores.

18. Preparation process according to claim 3, wherein the microorganisms introduced into the fermentation support are chosen from the group consisting of Penicillium roqueforti, Penicillium album, Geotrichum candidum, Staphylococcus carnosus and Staphylococcus xylosus spores.

19. Preparation process according to claim 4, wherein the microorganisms introduced into the fermentation support are chosen from the group consisting of Penicillium roqueforti, Penicillium album, Geotrichum candidum, Staphylococcus carnosus and Staphylococcus xylosus spores.

20. Preparation process according to claim 5, wherein the microorganisms introduced into the fermentation support are chosen from the group consisting of Penicillium roqueforti, Penicillium album, Geotrichum candidum, Staphylococcus carnosus and Staphylococcus xylosus spores.
